(19) United States
(12) Patent Application Publication
(10) Pub. No.: US 2017/0249681 A1
(43) Pub. Date: Aug. 31, 2017

(54) VEHICLE DELIVERY SYSTEM

(71) Applicant: CRISTIANO FERRARI, Marina Del Rey, CA (US)

(72) Inventor: CRISTIANO FERRARI, Marina Del Rey, CA (US)

(21) Appl. No.: 15/056,005

(22) Filed: Feb. 29, 2016

(51) Int. Cl. G06Q 30/06; G06Q 10/08

(52) U.S. Cl. CPC G06Q 30/0617; G06Q 30/0643; G06Q 10/0833

(57) ABSTRACT

A vehicle preparation and delivery method has the steps of the user logging in to the system providing a salesperson menu for a salesperson comprising the steps of viewing the status of vehicles in progress by a stock reference, requesting a car and scheduling a car delivery time; and providing a porter menu for a porter comprising the steps of displaying in progress requests indexed by stock reference, delivering the vehicle, and informing whether the vehicle has been sold or not sold and returned to the garage, and locating the vehicle, comprising displaying a map of the garage location of the vehicle and the location within the garage, displaying adjacent vehicles and suggesting which adjacent vehicles must be removed to remove the vehicle, and adding one or more completed actions in association with the vehicle.

### BACKGROUND OF THE INVENTION

1. Field of Invention

This invention relates to a system for monitoring delivery of new vehicles, and in particular, a system for monitoring progress of vehicle preparation for delivery and estimated time of arrival.

2. Description of Related Art

In the art, car dealerships have struggled with the vehicle preparation process after delivery. There are a number of different parties involved, each generally using an analog means for recording the preparation steps, and a lack of communication makes it difficult to track the progress of a vehicle being prepared for delivery.

The vehicles must often be tracked by identification numbers to multiple storage locations, and as a result of maximizing storage space, cars are often parked in front of, and blocking, the purchased car. Therefore it is difficult to determine which keys are required to free a car from storage. Then, a checklist of steps to prepare the car must be undertaken, such as a rudimentary inspection, detailing, registration and other administrative tasks, each often by a different party, without any centralized means to track the progress and estimate delivery for the customer.

Therefore there is a need for a tracking system to monitor the progress of preparation of a car for delivery once it is sold, including determining the location of the vehicle, removing the vehicle from its parking spot and determining which cars may be blocking the vehicle, and tracking all the items required to prepare the vehicle for delivery and estimating a delivery time to a customer.

### SUMMARY OF THE INVENTION

The present invention provides an effective system for managing delivery of new vehicles including monitoring progress in preparation for delivery and estimating time of arrival for the vehicle.

A vehicle preparation and delivery method has the steps of the user logging in to the system providing a salesperson menu for a salesperson comprising the steps of viewing the status of vehicles in progress by a stock reference, requesting a car and scheduling a car delivery time; and providing a porter menu for a porter comprising the steps of displaying in progress requests indexed by stock reference, delivering the vehicle, and informing whether the vehicle has been sold or not sold and returned to the garage, and locating the vehicle, comprising displaying a map of the garage location of the vehicle and the location within the garage, displaying adjacent vehicles and suggesting which adjacent vehicles must be removed to remove the vehicle, and adding one or more completed actions in association with the vehicle.

The preparation and delivery method may have the further step of a porter searching for one or more vehicles by VIN, and may have the further step of requesting the car for an auto show. The completed actions may be selected from the group consisting of washing the car, filling with gas, and performing mechanical review.

The preparation and delivery method wherein returning the vehicle to a garage may have the steps of selecting the garage, selecting a parking spot within the garage, driving the vehicle to the parking spot, and recording an odometer reading in association with the vehicle.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a system diagram of the vehicle delivery system, according to an embodiment of the present invention;

FIG. 2 is a screen series showing the system, according to an embodiment of the present invention;

FIG. 3 is a screen series showing a part of the system, according to an embodiment of the present invention;

FIG. 4 is a screen series showing a part of the system, according to an embodiment of the present invention;

FIG. 5 is a screen series showing a part of the system, according to an embodiment of the present invention;

FIG. 6 is a screen series showing a part of the system, according to an embodiment of the present invention.

### DETAILED DESCRIPTION OF PREFERRED EMBODIMENTS

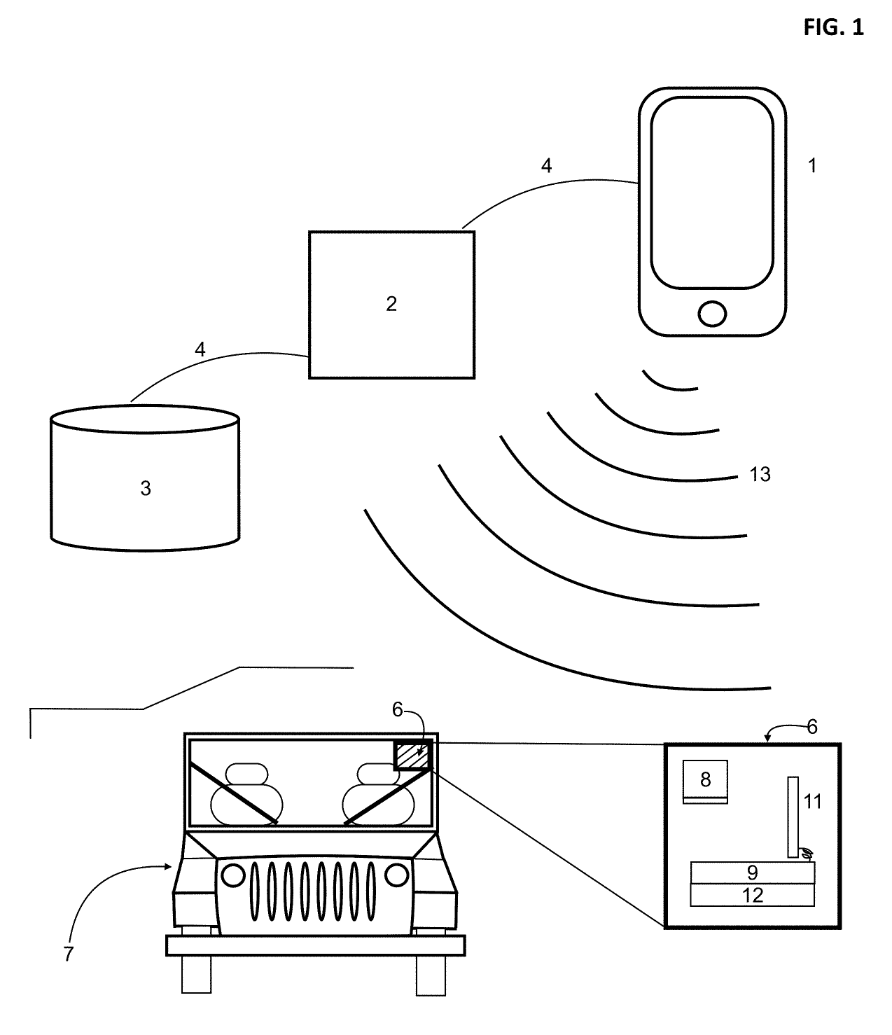

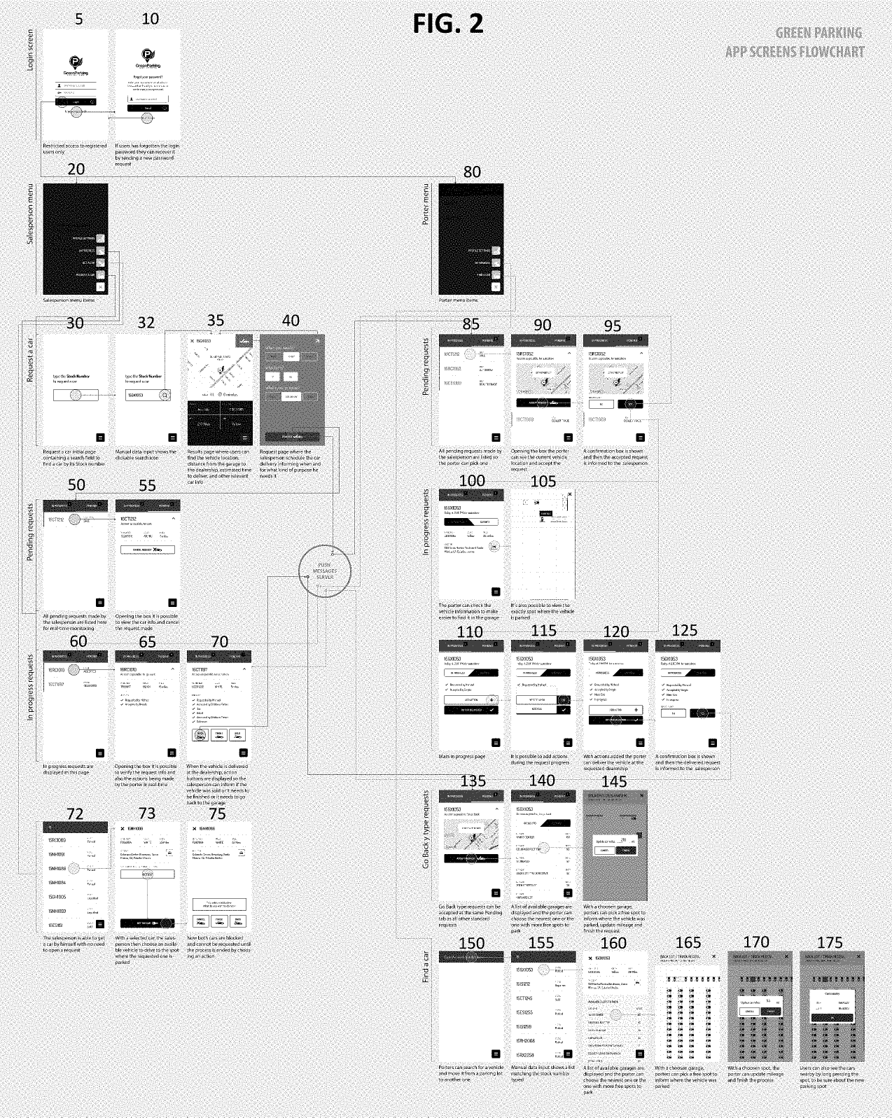

Preferred embodiments of the present invention and their advantages may be understood by referring to FIGS. 1-6 wherein like reference numerals refer to like elements.

In an embodiment, FIG. 1 is a system diagram of the vehicle delivery system, according to an embodiment of the present invention. The system has an application loaded on a mobile device 1 or computer console, which allows for user input. The application 2 is in communication with a server by a network 4. A database 3 resides on the server and contains details of all dealer vehicle inventory, tracking vehicles by date of entry and Vehicle Identification Number (VIN). Other details of the vehicle such as make and model, style, color, options, and real-time mileage are updated and available through the system.

When vehicles are received at the Port of Entry, they are recorded in the system through a mobile device 1, wherein the data on the vehicle is stored in the database 3. The location of the vehicle, once it arrives at the designated warehouse or storage area, is associated with the vehicle, along with the position within the warehouse. The position between the location of the vehicle and delivery location or dealership is used to calculate the transit time in the delivery time calculation.

A layout of a garage is established based upon the location's dimensions and available spaces. Each space may house one or more vehicles. A vehicle is parked in a space and a user indicates the specific space location through the system. The information of the vehicle location in a particular space is then saved and shared throughout the system.

In an embodiment, a locator 6 is placed in a vehicle 7. The locator 6 has a power source, such as a battery 8, electrically connected to a processor 9, a transmitter 11, and storage media 12. The locator 6 is a device coded to the specific vehicle where the locator is in communication with the system. Specific details of the vehicle are uploaded to the locator 6 and the locator 6 transmits a unique signal to the system showing the vehicle's 7 location. The locator 6 transmits a signal through a wireless network 13 such as Wi-Fi or Bluetooth. In an alternative embodiment, the locator 6 engages the vehicle 7. For example, the locator 6 communicates with the vehicle through an OBD port existing within the vehicle. The locator 6 can receive information regarding statistics on the vehicle including fuel levels and mileage.

Once the vehicle is in inventory, the vehicle may be marked for delivery by a salesperson, wherein the date and time of the salesperson's request is stored. The estimated time of arrival, when ordered by a salesperson for delivery to a purchaser, for example, is calculated by consideration of the location of the vehicle, including distance to the customer or the dealership, the number of cars (and availability of keys) that must be moved before the vehicle at issue may be removed, as well as the steps in processing the vehicle including a service, detailing and cleaning of the vehicle, and removal of stickers and pre-delivery. The system presents the request whereby the request is accepted by another user. Once the request has been accepted, the other user engages the system to identify the specific location of the vehicle including necessary components to operate the vehicle such as keys. Based upon the details provided by the system, the vehicle is located and the other user transports the vehicle from the garage to the salesperson. In an embodiment, the salesperson receives progress updates as the system identifies movement and operations of the other user in delivering the vehicle.

The delivery of the vehicle is recorded in the database and details of the delivery such as the date and time, location and person responsible. Upon delivery, the sales system identifies that the vehicle has been delivered and requests confirmation from the salesperson as to the delivery and condition of the vehicle.

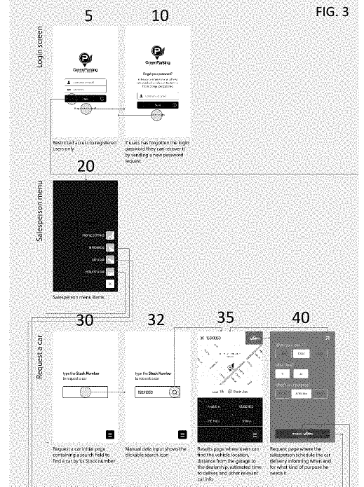

With reference to FIG. 3, the splash page and login is shown in step 5. If a user has a login, he or she may enter it to gain access to the system. Otherwise, the user may input username or email to retrieve a forgotten password at step 10, or may return to the login page if he or she went to a forgotten password by mistake. Once in the system, there is a salesperson system for ordering a car to be prepared and delivered, and a separate porter view for the porter or other car preparation personnel, described below.

In an embodiment, FIG. 3 shows that in step 20 a salesperson menu is provided with buttons for i) profile settings, ii) viewing status of vehicles “in progress” and iii) requesting a car. In profile settings, the salesperson may adjust his or her settings, including user ID, photo and password. If the salesperson selected viewing the status of requests, the system advances to step 50 below. If the salesperson selects requesting a car, at step 30 the screen requests a stock number for the car, wherein the number may be added manually through typing in step 32 or voice recognition, or may be searched based on the first few characters. In an embodiment, the number is a Vehicle Identification Number (VIN). Once the number is confirmed and searched, at step 35 a results page is shown where users can find a vehicle location, distance from the garage to the dealership, estimated time to deliver, and other relevant car information, such as color, mileage and model/trim level. Should the salesperson select the vehicle, at step 40 a request page is shown wherein the salesperson schedules a car delivery time and describes for what purpose he needs it, for example a car show or demonstration, or a sale.

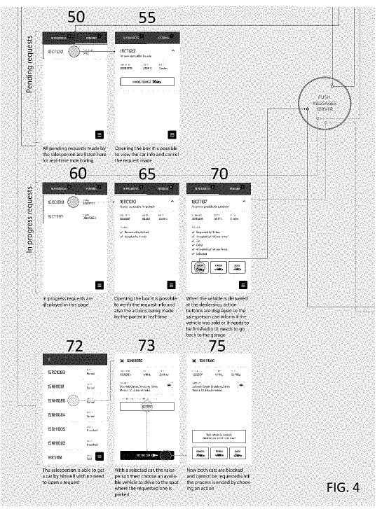

In an embodiment, FIG. 4 shows that once the salesperson chooses to advance by clicking “proceed” at step 50 the list of pending vehicles is shown updated in real time, with the vehicle most recently added at the bottom of the list. In the list view, the identification number for the vehicle is shown, in some embodiments further characteristics are shown (make, model, color) and the request date is shown. If any of the summary listings are selected, a detail view is shown at step 55, wherein the salesperson is provided with the progress status (pending or delivered), identifying characteristics (make, model, color, mileage), with a button to cancel the request.

In step 60, “in progress” requests are displayed. If one of the in-progress requests are selected, further detail is provided at step 65 and the request information is shown in real time as well as a list of steps taken by the porter in preparing the car for delivery and delivering the car (entered on the porter interface, described below). It may show the identification number, the color and mileage, as well as the requestor and acceptor (porter) for the request. In step 70, the vehicle is delivered to the dealership wherein action buttons are displayed so the salesperson can inform the system if the vehicle was sold (completing the request) or if the vehicle needs to be returned to the garage (not sold). If the vehicle is going back to the garage, the procedure moves to step 135.

In an embodiment, at step 72, the salesperson is able to get a car by himself with no need to open a request. At step 73, with a selected vehicle, the salesperson then chooses an available vehicle to drive to the spot where the requested vehicle is parked. At step 75, both the taken vehicle without request and requested vehicle are blocked and cannot be requested by another user until the process is ended by choosing an action. In an embodiment, if the process is not ended within a given timeframe a manager is notified in order to make the vehicles available. In an embodiment, a manager is able to override a blocked vehicle.

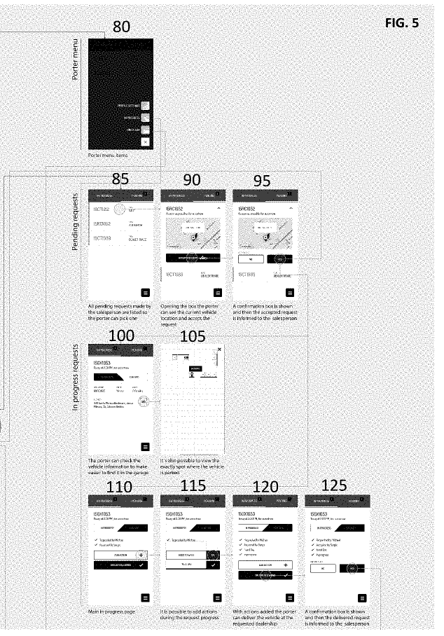

In an embodiment, FIG. 5 shows that at step 80, the porter menu is shown wherein the porter may select i) profile settings, ii) reviewing in progress requests, and iii) finding a car. In profile settings, the porter may adjust his or her settings, including user ID, photo and password. If the porter chooses to find a car, then the procedure is advanced to step 150.

If the porter selects viewing pending requests, a list is shown wherein the requests are indexed by identification number or VIN, and ordered by urgency (the amount of time in which the request requires attention from the porter). At step 85, if the porter selects one of the requests, the porter receives information on the current vehicle, including the location, and can accept the request. At step 90, if the porter accepts the request, a confirmation box is shown at step 95 and the acceptance is communicated to the salesperson.

If the porter selects “in progress” requests, the porter clicks on the vehicle and can verify the vehicle information at step 100. A parking icon is shown and may be clicked to enable viewing exactly where the vehicle is parked at step 105. A diagram of the storage location having an entrance/exit is shown with a number of parking spots shown. The location of the vehicle at issue is highlighted, and other vehicles between the exit and the vehicle are highlighted. Clicking on each of these provides an identification number for the vehicle so that keys may be retrieved in advance and brought to the storage location along with the key of the vehicle at issue.

Having selected a vehicle and accepted the request at step 90 and confirmed at step 95, in step 110 the main “in progress” screen is shown, along with the users making the request and users accepting the request. Actions may be added by clicking the add button. When an action is added at step 115, a selection of tasks is provided, such as need to wash, need gas, mechanical review etc. and each task may be selected and added to the “to do” list reflected on the screen in step 120, which is the same screen as in step 110 with tasks added. a button may be selected in each of the screens for car delivery, for which a confirmation screen is provided at step 125, which completes the process and removes pending tasks. The car is removed from the “in progress” list.

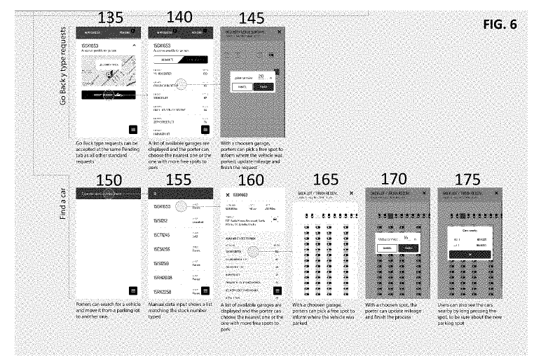

In an embodiment, FIG. 6 illustrates that if the vehicle is returned to the garage instead of being marked as sold, in step 135, the “go back” request can be accepted at the same “pending” tab as other requests. A button for accepting the request brings the porter to step 140, wherein a list of available garages is displayed, and wherein the porter chooses the nearest one or one with a free spot. Once the garage is chosen in step 140, at step 145 a parking spot is chosen for the car and the vehicle's mileage is updated. When the car is confirmed returned the task is closed.

In an embodiment, when a porter chooses to find a car in step 80, in step 150 the porter may search for a vehicle and move it from one parking lot to another one. The porter may search for a vehicle by identification number such as a VIN. A list showing a number of vehicles is shown in step 155, wherein the vehicle may be selected from the list. Once a vehicle is selected, in step 160 a list of available garages is displayed and the porter can choose the nearest one or the one with available spots. Once a parking garage is selected, in step 165 a garage layout is shown and porters may select a free spot to inform where the vehicle will be parked. In step 170, the porter can update the mileage based on the parking location selection and complete the process. In an alternative embodiment, updated information for the vehicle, such as mileage and fuel levels are updated automatically through the locator device, where the locator device is in communication with the system and in communication with the vehicle. In step 175, users can also see the cars nearby by long pressing the spot, to be sure about the new parking spot.

When the vehicle is removed from a space, the system is reconfigured to identify that space as open. When the vehicle is returned to a space, the space is shown as occupied in the system.

In an alternative embodiment, the salesperson registers a request for a vehicle in the system for use at a special event such as an auto show. The porter accepts the resulting auto-show request and the vehicle is located. Special instructions for vehicle preparation are made based upon the special event. For example, an auto-show request may include instructions for washing the vehicle; filling the fuel tank; or adding logos and graphics for display.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A vehicle preparation and delivery method, comprising the steps of:
a. the user logging in to the system;
b. providing a salesperson menu for a salesperson comprising the steps of:
i. viewing the status of vehicles in progress by a stock reference, and
ii. requesting a car and scheduling a car delivery time; and
c. providing a porter menu for a porter comprising the steps of:
i. displaying in progress requests indexed by stock reference;
ii. delivering the vehicle, and informing whether the vehicle has been sold or not sold and returned to the garage; and
iii. locating the vehicle, comprising
1. displaying a map of the garage location of the vehicle and the location within the garage;
2. displaying adjacent vehicles and suggesting which adjacent vehicles must be removed to remove the vehicle; and
3. adding one or more completed actions in association with the vehicle.

2. The preparation and delivery method of claim 1 further comprising the step of a porter searching for one or more vehicles by VIN.

3. The preparation and delivery method of claim 1 further comprising the step of requesting the car for an auto show.

4. The preparation and delivery method of claim 1 wherein the completed actions are selected from the group consisting of washing the car, filling with gas, and performing mechanical review.

5. The preparation and delivery method of claim 1 further comprising the step of returning the vehicle to a garage comprising the steps of:
a. selecting the garage
b. selecting a parking spot within the garage; and
c. driving the vehicle to the parking spot; and
d. recording an odometer reading in association with the vehicle.
